(19) United States
(12) Patent Application Publication
(10) Pub. No.: US 2017/0195389 A1
(43) Pub. Date: Jul. 6, 2017

(54) SYSTEM AND METHOD FOR RAPID MANAGEMENT OF LARGE SCALE VIDEO

(71) Applicant: Electronics and Telecommunications Research Institute, Daejeon (KR)

(72) Inventors: Young Suk YOON, Chungcheongbuk-do (KR); Kyoung PARK, Daejeon (KR); Jong Youl PARK, Daejeon (KR)

(21) Appl. No.: 15/218,543

(22) Filed: Jul. 25, 2016

(30) Foreign Application Priority Data
Jan. 4, 2016 (KR) 10-2016-0000293

(51) Int. Cl. H04L 29/06; H04L 12/26

(52) U.S. Cl. CPC H04L 65/601; H04L 43/16

(57) ABSTRACT

Provided is a large scale video management system including: a video random binary stream calculator configured to generate a video random binary stream while changing a setting of a random threshold in an entire section of an input video; a video quality measurer configured to measure a quality of the input video; and a video replacement determiner configured to search whether a video having the same value as the video random binary stream generation value is previously stored, and compare a quality of the previously stored video with a quality of the input video to replace with a high quality video when the video having the same value as the video random binary stream generation value is previously stored.

### CROSS-REFERENCE TO RELATED APPLICATION

This application claims the benefit of priority to Korean Patent Application No. 10-2016-0000293, filed on Jan. 4, 2016 in the Korean Intellectual Property Office, the disclosure of which is incorporated herein in its entirety by reference.

### BACKGROUND OF THE INVENTION

Field of the Invention

The present disclosure relates to a system and a method for a rapid management of large scale video, and more particularly, to a technology that searches a duplicated video at a high speed and checks the quality integrity to replace with a high-quality video so that it is possible to efficiently manage large scale video.

Description of the Related Art

Due to the appearance of smart devices and the development of wireless communication technology, the use environment of digital contents is changed so that digital contents may be enjoyed at anytime and anywhere in addition to in a fixed place. According to the current of the times, service providers launch the contents uploading, the contents downloading, and the contents streaming services so that users may easily enjoy contents at anytime and anywhere using a smart device.

However, in order to provide these services, service providers require a technology of storing and effectively managing a huge amount of contents that occur every moment. In the YouTube server that provides a video service that is played all around the world, video data in 300 hours are uploaded per minute in 10 years after starting the service.

The duplicate alternative technology of the related art is a complicated method of searching and matching the same contents by using a fingerprint or a characteristic feature technology, which consumes a lot of time and resource so as to search and compare an entire video section. Particularly, when introducing the related art so as to manage large scale video of petabyte or zettabyte scale not terabyte scale, the load of introduced system is suddenly increased and a lot of resources are required.

### SUMMARY OF THE INVENTION

The present disclosure has been made in view of the above problems, and provides a system and a method for a rapid management of large scale video capable of rapidly determining duplication of video by comparing characteristics of the entire video, measuring quality to check integrity and replacing with more high-quality video.

Specifically, the present disclosure provides a technology of rapidly determining duplication of the video having a different setting (video frame size, video frame rate, compression rate of video, audio sampling rate, audio compression rate, etc.) of a coded encoder and a different type and setting of multiplexed digital container format (DCF), measuring quality, and checking integrity and replacing with high-quality video.

In accordance with an aspect of the present disclosure, a large scale video management system includes: a video random binary stream calculator configured to generate a video random binary stream while changing a setting of a random threshold in an entire section of an input video; a video quality measurer configured to measure a quality of the input video; and a video replacement determiner configured to search whether a video having the same value as the video random binary stream generation value is previously stored, and compare a quality of the previously stored video with a quality of the input video to replace with a high quality video when the video having the same value as the video random binary stream generation value is previously stored.

The large scale video management system further includes a surplus video clip remover that identifies and removes a surplus video clip which is unnecessary information in the video.

The surplus video clip remover includes: a video clip identifier configured to identify whether there is a surplus video clip in a video input from a video preprocessor; and a video clip remover configured to receive information on a section where the surplus video clip exists from the video clip identifier and to remove the surplus video clip.

The surplus video clip remover removes a portion corresponding to a section of the surplus video clip received from the video clip identifier in a video elementary stream (ES) and an audio ES of the input video, and updates time information and removes the same section in the video ES and the audio ES of the input video to be stored in the video non-duplication database.

The large scale video management system further includes a video preprocessor configured to normalize a format of the video.

The video preprocessor includes: a video de-multiplexer configured to multiplex the video into a video elementary stream (ES) and an audio ES; a video decoder configured to decode the de-multiplexed video ES and audio ES; and a video normalizer configured to normalize a of the decoded video.

The video random binary stream calculator includes: a video cube generator configured to generate a single cube for the input video and generate a frame by stacking a single cube as several layers; a video characteristic calculator configured to extract characteristic for the cube; a video random threshold calculator configured to calculate a video random threshold by using the extracted characteristic; and a video binary stream calculator configured to calculate the video random binary stream by using the video random threshold.

The video quality measurer includes: a video quality calculator configured to calculate a quality of the input video; and a video integrity verifier configured to verify integrity of the input video.

The video replacement determiner includes: a video random binary stream comparator configured to determines whether a video corresponding to the random binary stream of the input video is previously stored; and a video quality comparator configured to compare the previously stored video with a quality of the input video, when the video corresponding to the random binary stream of the input video is previously stored.

The video quality comparator maintains the previously stored video when a quality of the previously stored video is higher than a quality of the input video.

The video quality comparator replaces the previously stored video with the input video when a quality of the previously stored video is lower than a quality of the input video.

The large scale video management system further includes a video non-duplication database configured to store at least one of a non-duplication video, video information, video additional information, and surplus video clip information.

In accordance with another aspect of the present disclosure, a large scale video management method includes: generating a video random binary stream while changing a setting of a random threshold in an entire section of an input video; measuring a quality of the input video; searching whether a video having the same value as the video random binary stream generation value is previously stored; comparing a quality of the previously stored video with a quality of the input video, when the video having the same value as the video random binary stream generation value is previously stored; and replacing with a high quality video among the previously stored video and the input video.

The large scale video management system further includes: normalizing a format of the input video, before generating a video random binary stream.

The large scale video management system further includes: identifying and removing a surplus video clip which is unnecessary information in the normalized video.

### BRIEF DESCRIPTION OF THE DRAWINGS

The objects, characteristics and advantages of the present disclosure will be more apparent from the following detailed description in conjunction with the accompanying drawings, in which:

FIG. 1 is a diagram illustrating a configuration of a large scale video management system according to an embodiment of the present disclosure;

FIG. 2 is a diagram illustrating a detailed configuration of a video preprocessor of FIG. 1;

FIG. 3 is a diagram illustrating a detailed configuration of a surplus video clip remover of FIG. 1;

FIG. 4 is a diagram illustrating a detailed configuration of a video random binary stream calculator of FIG. 1;

FIG. 5A is a diagram illustrating an example of a cube frame by a cube generator of FIG. 4;

FIG. 5B is a diagram illustrating an example of a single cube in a cube frame of FIG. 5A;

FIG. 6 is a diagram illustrating a Gaussian graph which is one of distribution of data according to an embodiment of the present disclosure;

FIG. 7 is a diagram illustrating an example of expressing a video ES characteristic of one hour video as a histogram according to an embodiment of the present disclosure;

FIG. 8 is a diagram illustrating an example of expressing a random binary stream as a histogram according to an embodiment of the present disclosure;

FIG. 9 is a diagram illustrating another example of expressing a random binary stream as a histogram according to an embodiment of the present disclosure;

FIG. 10 is a diagram illustrating a detailed configuration of a video quality measurer of FIG. 1;

FIG. 11 is a diagram illustrating a detailed configuration of a video replacement determiner of FIG. 1;

FIG. 12 is a diagram illustrating a detailed configuration of a video non-duplication DB of FIG. 1;

FIG. 13 is a flowchart illustrating a large scale video management method according to an embodiment of the present disclosure; and

FIG. 14 is a diagram illustrating a computer system implementing the large scale video management method according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

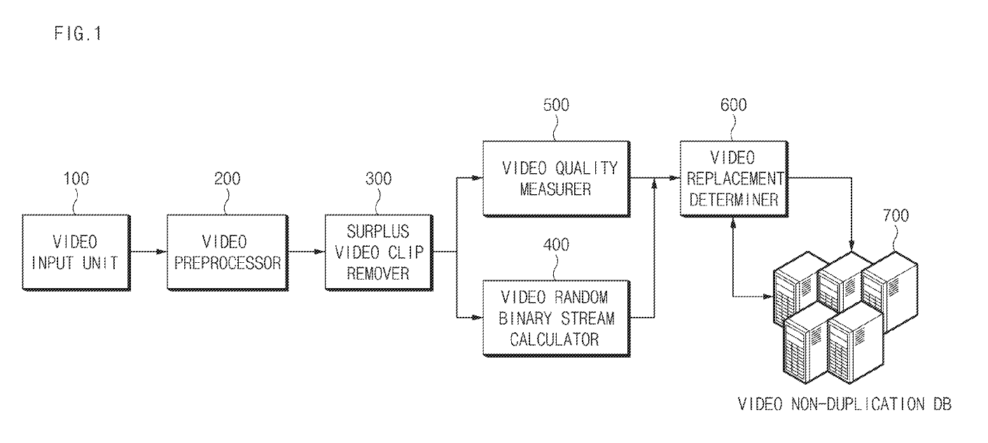

FIG. 1 is a diagram illustrating a configuration of a large scale video management system according to an embodiment of the present disclosure.

The large scale video management system according to an embodiment of the present disclosure may include a video input unit 100, a video preprocessor 200, a surplus video clip remover 300, a video random binary stream calculator 400, a video quality measurer 500, a video replacement determiner 600, and a video non-duplication database 700.

The video input unit 100 may receive video from various users (ex. person, some service providers, distributors, etc.). In this case, the user may input video in such a manner of uploading user's own video into a system (ex. various video services provided by a cloud) which manages a large scale video.

The video preprocessor 200 may normalize format of input video. That is, the videos input from the user may exist as various forms (DCF) and various compressed ES (video ES or audio ES) configuring video.

In addition, since each video ES and audio ES include various video encoder, video compression rate, video frame size, video frame rate, audio encoder, audio compression rate, audio channel, and audio sampling rate due to the setting of the encoder and the multiplexed digital container format, normalizing is required to replace duplicated video.

The surplus video clip remover 300 may remove an unnecessary surplus video clip portion included in many videos. That is, since a portion of containing actual content in the video may include an unnecessary clip portion such as distributor, manufacturer, intro/ending of video, advertisements, etc, a section corresponding to this surplus video clip is searched to be removed. This clip removal technology may use a conventional technology.

The video random binary stream calculator 400 may calculate a characteristic for replacing duplication according to time axis in entire section of each ES and calculate a random threshold and generate a random binary stream when the video ES and the audio ES normalized and decoded from the video input after the surplus video clip is removed is entered.

The video quality measurer 500 may measure the quality according to time axis in entire section of each ES when the video ES and the audio ES normalized and decoded from the video input after the surplus video clip is removed is entered. In addition, the video quality measurer 500 may compare information of quality which can be obtained from header by using information of DCF header which can be obtained from video with the measured quality and may determine quality integrity to determine whether the quality of the input video is reliable, and a task may be stopped or it may proceed to the next task depending on a system policy with respect to the video which does not guarantee integrity.

The video replacement determiner 600 may inquire a random binary stream calculated from the video random binary stream generator 400 of the video non-duplication database 700 and may search whether the same video exist in the video non-duplication database 700.

If the same video does not exist in the video non-duplication database 700, the video replacement determiner 600 may store a corresponding video into the video non-duplication database 700 together with space-time quality values measured in the video quality measurer 500. On the other hand, if the same video exists in the video non-duplication database 700, the video replacement determiner 600 may compare the quality of the previously stored video with the quality of the video measured in the video quality measurer 500. Based on the comparison result, if the quality of the video which is previously stored in the video non-duplication database 700 is better than the quality of the video measured in the video quality measurer 500, the video replacement determiner 600 may maintain the storing of the previously stored video. On the other hand, if the quality of the video which is previously stored in the video non-duplication database 700 is worse than the quality of the video measured in the video quality measurer 500, the video replacement determiner 600 may delete the video previously stored in the video non-duplication database 700 and replace with the video measured in the video quality measurer 500. That is, if the quality of the input video ES is better, replacement is accomplished. Otherwise, replacement is not accomplished. If the replacement is accomplished, corresponding video information is also updated in the video non-duplication database 700.

The video non-duplication database 700 may initially start at an empty state and store only a better quality ES without the duplicated ES. In addition, the video non-duplication database 700 may store random binary streams of entire section of each video ES and audio ES and information on the space-time quality values.

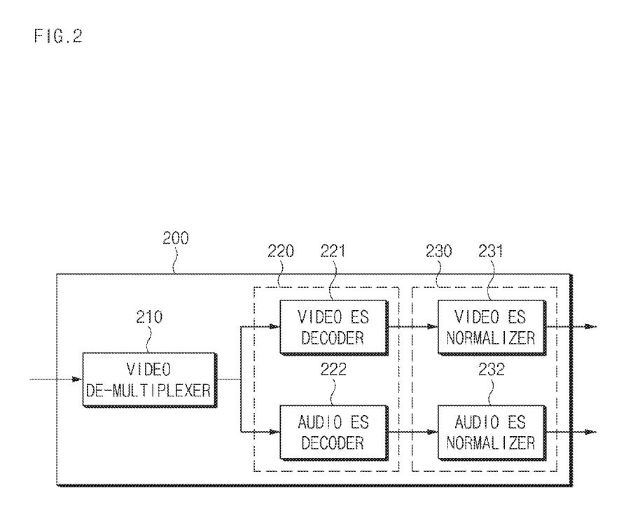

FIG. 2 is a diagram illustrating a detailed configuration of a video preprocessor of FIG. 1.

The video preprocessor 200 may include a video de-multiplexer 210, a video decoder 220, and a video normalizer 230.

The video de-multiplexer 210 may multiplex the input video into the video ES and the audio ES.

The video decoder 220 may include a video ES decoder 221 and an audio ES decoder 222. The video ES decoder 221 may decode the video ES in accordance with encoder information of encoded video ES. The audio ES decoder 222 may decode the audio ES in accordance with encoder information of encoded audio ES.

The video normalizer 230 may include a video ES normalizer 231, and an audio ES normalizer 232. The video ES normalizer 231 may normalize the decoded video ES having a different format (video encoder, video compression rate, video frame size, video frame rate, audio encoder, audio compression rate, audio channel, audio sampling rate) so as to have the same format based on time/space. The audio ES normalizer 232 may normalize the audio ES having a different format so as to have the same format based on time/space.

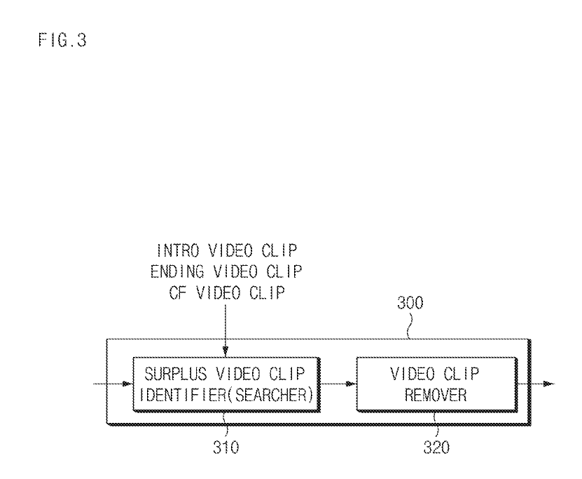

FIG. 3 is a diagram illustrating a detailed configuration of a surplus video clip remover of FIG. 1.

Most videos which user can easily obtain through various services and programs are a video that contains only actual content. However, in some cases, since it contains a surplus video clip in which actual users are not interested such as intro/ending/CF video clip or distributor information, theater information, and the like, such a video clip should be removed.

The surplus video clip remover 300 may be selectively operated when a clip to be removed exists within a video, and may store information on removed surplus video clip in a surplus video database of the video non-duplication database 700.

To this end, the surplus video clip remover 300 may include a surplus video clip identifier 310, and a video clip remover 320.

When the normalized video ES and audio ES output in pairs are entered simultaneously from the video preprocessor 200, the surplus video clip identifier 310 may search a surplus video clip. In other words, the surplus video clip identifier 310 may identify whether a video clip to be removed exists in the input video, and notify a section of the portion to be removed to the video clip remover 320.

The video clip remover 320 may remove a corresponding section in a corresponding video ES or audio ES according to section information received from the video clip of the surplus video clip identifier 310. At this time, the video clip remover 320 may remove the same section from the normalized and decoded video ES and audio ES, update time information (Time Stamp), and also remove the same section of the video ES and the audio ES of the input video to be stored later in the video non-duplication database 700. If the surplus video clip is removed, only the portion having a pure content of the video is left.

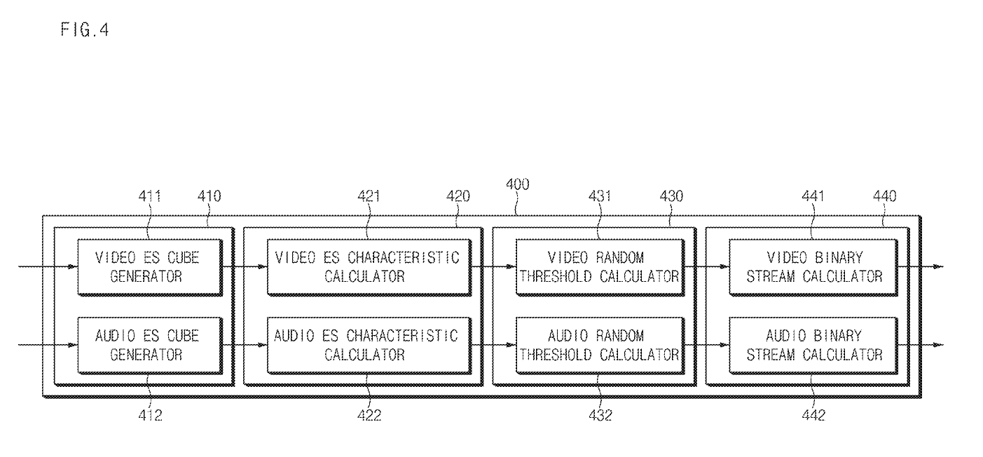

FIG. 4 is a diagram illustrating a detailed configuration of a video random binary stream calculator 400 of FIG. 1.

The video random binary stream calculator 400 may express the entire data through a plurality of outputs generated in a simple way by calculating a binary stream of the video. To this end, the video random binary stream calculator 400 may include a video cube generator 410, a video characteristic calculator 420, a video random threshold calculator 430, and a video binary stream calculator 440. At this time, each element may be configured in response to the video ES and the audio ES signals.

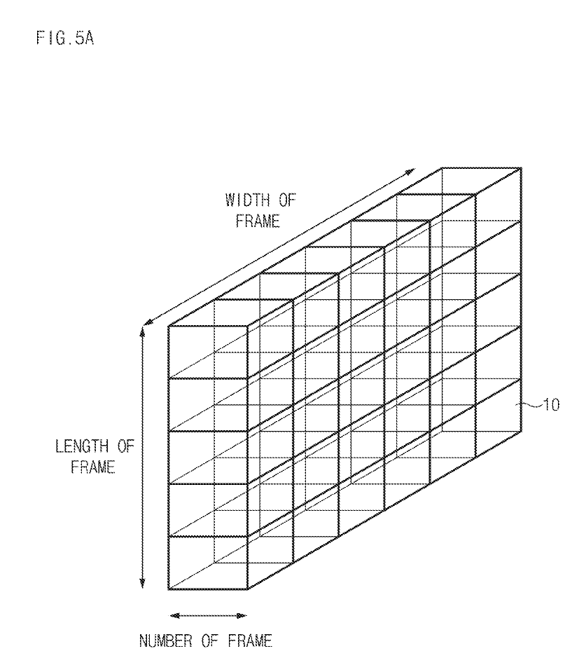

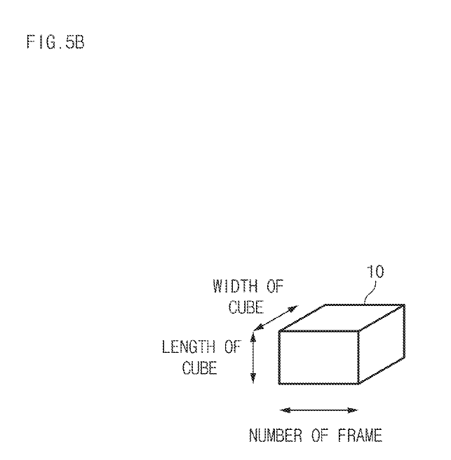

The video cube generator 410 may collect the decoded video in time and space so that the divided and generated characteristic of the video may be concentrated and duplicated. That is, the video cube generator 410 may stack the decoded video as shown in FIG. 5A in a frame 10 unit of FIG. 5B and generate a cube so that it may have multiple layers and process in time and space. At this time, the video cube generator 410 may include a video ES cube generator 411 for video ES and an audio ES cube generator 412 for audio ES.

Referring to FIG. 5A, the video cube generator 410 may generate to have multiple layers by stacking using the same size of a cube. Depending on a utilized example, it is possible to use a three-dimensional cube of different size like a two-dimensional AVC codec. Pixels adjacent in time and space may be located in a single cube to have a similar value, and adjacent cube also may be likely to be configured in a similar value.

In the case of extracting a characteristic from video ES by using only a single frame, the number of the frame may be 1 such that a time factor is ignored and only a spatial factor is considered. In addition, assuming that a domain for the length, the width, and the number of each frame is orthogonal so as not to use a three-dimensional conversion, the video cube generator 410 may be used in such a manner that the length, the width, and the number are fixed respectively to 1 once and three two-dimensional planes are provided. In the audio ES, the length and the width of a frame of one (mono) channel may be identically set to 1, which corresponds to a special case in which the pixel is 1 in the video ES. When the audio ES is multi-channels which are two channel or more, a cube may be generated by collecting a channel of similar nature or a cube may be generated by converting into a single channel. In addition, the video cube generator 410 may not generate a cube by discontinuously collecting frames so as to additionally use temporal information, but may duplicate and use the frame when generating the next cube.

The video characteristic calculator 420 may receive the values (the pixel value video ES or the audio source value of audio ES and the like) collected in the form of a cube from the cube generator 410, and extract characteristic from a current space-time domain. The video characteristic calculator 420 may be able to extract characteristic by converting into other domain for processing data. The video characteristic calculator 420 may adopt and use the existing family patent or the method of other invention according to the characteristic and requirements of a system.

The video random threshold calculator 430 may randomly calculate a threshold by using characteristic extracted from the video characteristic calculator 420, and the video binary stream calculator 440 may generate a random binary stream by using a random threshold.

At this time, the video random threshold calculator 430 may binarize the characteristic calculated in the video characteristic calculator 420 to simply express. Binarization is a special case of quantization that sorts class into two groups which are 0 and 1 respectively. The quantization method is a representative method that helps to express analog data (ex. real number, etc.) that cannot be expressed by a machine into digital data (ex. binary data) that can be used by the machine. However, the quantization method has a disadvantage in that a portion of data disappears due to a quantization error. In addition, there is a problem of generating a classification error that sorts a reference for classifying data, a threshold, and, more broadly, data concentrated near decision boundary into a different class according to criteria.

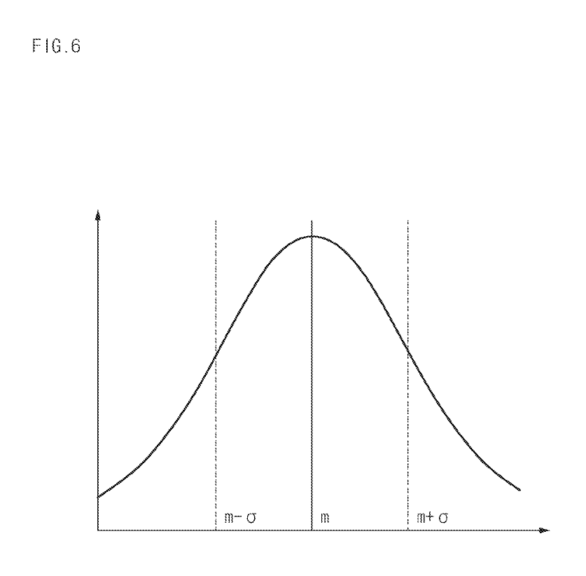

FIG. 6 is a diagram illustrating a Gaussian graph which is one of distribution of data according to an embodiment of the present disclosure. Here, m is a mean and σ is a standard deviation. Approximately 68.3% of total data are intensively distributed between the dotted line [m−σ, m+σ] based on the mean. Assuming that the threshold is considered mean, a value less than the threshold is considered 0, and a value equal to or more than the threshold is considered 1, many values are sorted into a different class even if the threshold is moved a little. Thus, the expression through binarization has a problem in that a part of data may be disappeared, or may be classified into a different class.

Thus, the video random threshold calculator 430 may randomly change the threshold based on a center (a different value such as a center value, mean, or the like that can express the middle of data may be used) and compensate for generating a quantization error and a classification error.

For example, when a random threshold is defined based on m as a center, the threshold may be expressed as m+rᵢ, rᵢ is a real number that is randomly selected from [−k*σ, k*σ], and k a real parameter of (0, 1] which is used to control a selection section. represents an i-th element expressing the characteristic calculated in the ES characteristic calculator. A setting value of the random threshold is {m+r₁, m+r₂, . . . m+rᵢ}. Thus, the calculated characteristics may be expressed in a binarized stream.

For example, when the video characteristic calculator 420 outputs a value of 29.9, the center is 30, r is [−1.2, 1.2], i is 4, r is randomly selected four times to output {−0.2, 1, 0.5, −0.3}, the random threshold setting value is {29.8, 31, 30.5, 29.7}, so that the output binarized stream is {1, 0, 0, 1}. Thus, the present disclosure may generate a binary stream while changing a random threshold and minimize the quantization error and the classification error. In addition, typical quantization methods may express a value of the calculated analog ES characteristic as a single value according to the assigned number of bit. In addition, the method of assigning bit may be a diverse and complex method such as a uniform method, an adaptive method and the like. However, the present disclosure may express the value of the calculated analog ES characteristic by a simple binarization method, and a reference for the expression may be performed by randomly changing the threshold.

The random threshold value which is randomly changed has been invented in order to minimize the side effects of both classification error and quantization error. An initial process of determining the random threshold value is random. However, the value should be fixed when it applies to each queried video on an application. Because it is a determining standard for the binarization of analog feature value.

When building a system using the present disclosure, firstly, the video characteristics calculator 420 may be selected according to the requirements of the system to build and characteristics may be previously calculated in sufficiently many videos. Here, a center used for the video random threshold calculator 430 may be merely predicted by using a sufficient number of previous data, but it is not the center including the data after the calculation of the center. Thus, the center, which becomes a reference of the threshold as time goes on, may gradually lose a function as the threshold, but the setting of the random threshold of the present disclosure may serves to remove this problem. However, the system may add a process of separately storing the values which are passed through the video characteristics calculator 420 from the input videos and newly updating the center, finally, the video random binary stream.

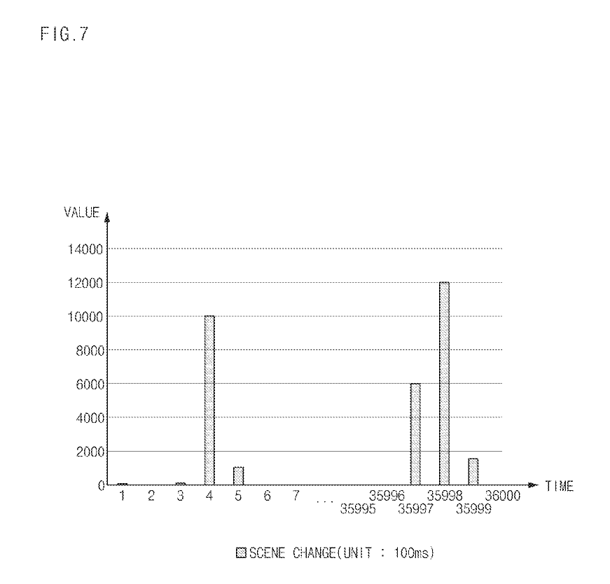

In this case, when arranging the calculated random binary stream on the time axis, the video binary stream calculator 440 may express this as a histogram which has a value in every time position of a full video length. A video ES characteristic calculator 421 may calculate the characteristic value in the following method. As shown in FIG. 7, a position or a value having a strong possibility of scene change may be indicated in the time axis. For example, FIG. 7 may indicate the value of the strong possibility of scene change in the video ES characteristic histogram using a time unit of 100 ms. In addition, it is indicated in the time axis by dividing into an x-axis direction and a y-axis direction using a specific pixel and a motion vector of block location. For example, when the motion vector is (3, 20) at a specific time, x-axis characteristic is 3, y-axis characteristic is 20, and x-axis histogram and y-axis histogram are drawn respectively. In addition, it may be expressed as intensity (distance to origin) to express as one dimension. An encoding method in an encoder which can select an intra-frame or inter-frame encoding method may be used. Since the scene may be changed or the movement due to the lapse of time in the object is big if the inter-frame encoding method is selected in the encoder, it may be expressed as 1 in the case of inter-frame, and it may be expressed as 0 in the case of intra-frame.

In addition, the video ES characteristic calculator 421 may use a pixel in a specific location, statistics (mean, variance, etc.), dominant color, and the like. It may use the number of a main object existing in a corresponding video frame. It may use the number of edges in accordance with each direction, or may calculate the video ES characteristic comparing a difference of the edge strength of the front and rear frames or a direction histogram. In this case, FIG. 7 shows a simple example of expressing the strength of scene change for the video ES in one hour video as a histogram.

An audio ES characteristic calculator 422 may determine whether there is silence (no sound) by using a strength of sound or a zero crossing rate (ZCR), similarly to the above video ES characteristic calculator 421. The audio ES characteristic calculator 422 may move a sliding window as much as a unit time, and may use a time domain, statistics in a frequency domain, a center value for each band, a mean, a representative value, and a median value. In addition to the described method, other method which can express in the time axis may be used, and all characteristics may be expressed in the form of a histogram along the time axis. A plurality of histograms may exist as described above.

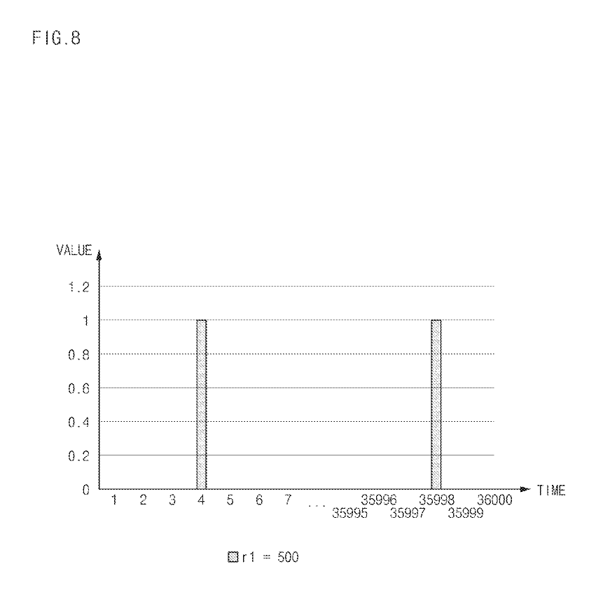

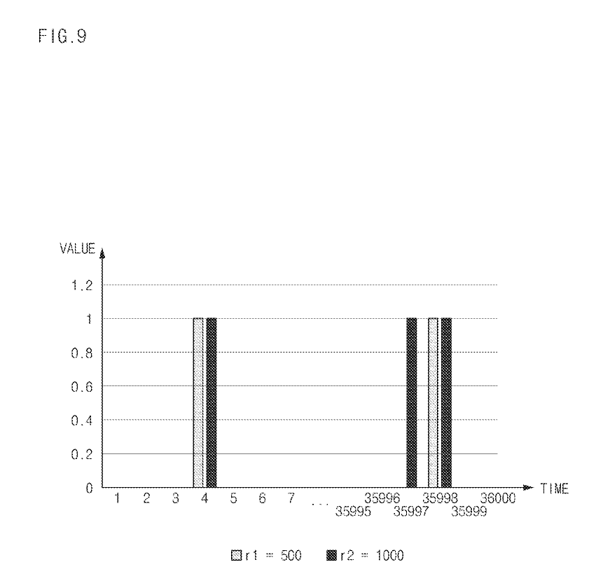

For example, when the characteristic streams calculated in each ES characteristic calculator 421, 422 are outputted as shown in FIG. 7, the video random binary stream generator 440 may output a random binary stream as shown in FIG. 7 and FIG. 8. In FIG. 8, a center is 7,000, a stream element i is 1, and r={500}. Thus, a random threshold becomes {7,500} to send an output like FIG. 7. In FIG. 8, a center is 7,000, a stream element i is 2, and r={500, −1,000}. Thus, a random threshold of FIG. 8 becomes {7,500, 6,000} to send an output like FIG. 8. The output random binary stream may be output like FIG. 8 or a total random binary stream may be output respectively according to rᵢ. In this case, FIG. 8 is a diagram illustrating an example of expressing a random binary stream as a histogram according to an embodiment of the present disclosure, and FIG. 9 is a diagram illustrating another example of expressing a random binary stream as a histogram according to an embodiment of the present disclosure.

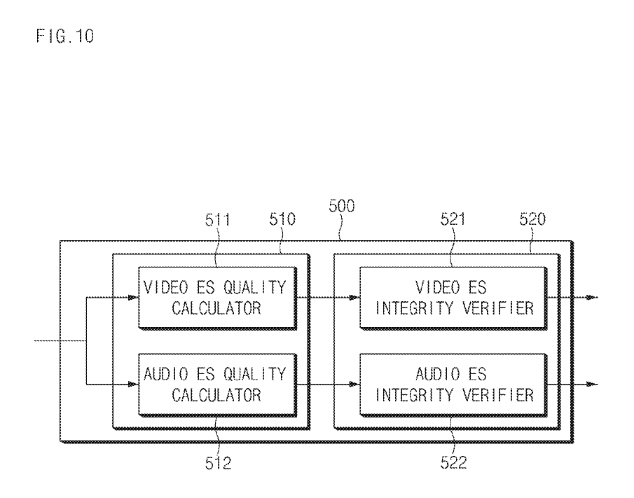

FIG. 10 is a diagram illustrating a detailed configuration of a video quality measurer 500 of FIG. 1.

The video quality measurer 500 may include a video quality calculator 510 and a video integrity verifier 520.

The video quality calculator 510 may calculate a space-time quality value from entire section of video because if only a space-time quality value of a specific part is calculated, it cannot represent an entire space-time quality value. At this time, when arranging the space-time quality value measured by the video quality calculator 510, it may be shown as a histogram having a value for each time position of a full-length of video.

At this time, the video quality calculator 510 may include a video ES quality calculator 511 and an audio ES quality calculator 512.

The video ES quality calculator 511 may measure a video quality and may check how much original video is encoded in a temporal area and a spatial area because the quality is determined according to the extent of encoding (compression) of the original video. Since s low-quality video which strongly compressed a signal in a video encoder has a low sharpness which is a high-frequency component, video frame seems to be smudged in the spatial area or seems to be cloudy. In addition, since the video encoder performs an encoding by using a motion vector occupying much part of encoding efficiency, the image is not properly reconstructed when the size of the motion vector is large, such that there may exist a difference with the original video. The degree of sharpness of the frame, and the occurred blocking artifacts may be expressed as a histogram in the time axis. At this time, the blocking artifacts may be measured by using a deblocking filter. It may be detected when it occurs, particularly, in the horizontal, and vertical directions in the edge. In addition, it is possible to express as a histogram in the time axis by using the magnitude of the motion vector or the magnitude of horizontal/vertical direction.

The audio ES quality calculator 512 may calculate quality of an audio and may measure a sound image which is the focus of an instrument sound or a voice, a resolution which indicates the degree of accurately expressing a sound, a timbre which indicates the degree of playing similarly, a sound field in which sound is spread, a liveliness which indicates the degree of expressing the dynamic of a sound, a density which indicates the degree of filling a space of sound, and the like.

The method of measuring the audio quality and the video quality is not limited to the above description and may be measured using a conventional technology and may express this quality measurements in the time axis.

The video integrity verifier 520 may verify the integrity whether there is a consistency of a space-time quality value output from the video quality calculator 510 and a DCF header that contains information of ES encoder. If a low quality is given as the measured space-time quality value is low although it is predicted that a high-quality is given as the compression ratio of the ES encoder is low in the DCF header, it may be the case in which a corresponding ES has used an audio line capture and a video cam capture or has re-encoded a low-quality video into a high-quality. In such a case of not guaranteeing integrity, the input ES may be abandoned as if the ES within DB is a high quality. In such a case of not providing the reliability of quality, the reliability of system may be increased by skipping the process of searching a duplicated video in the video non-duplication database 700.

The video integrity verifier 520 may include a video ES integrity verifier 521 and an audio ES integrity verifier 522.

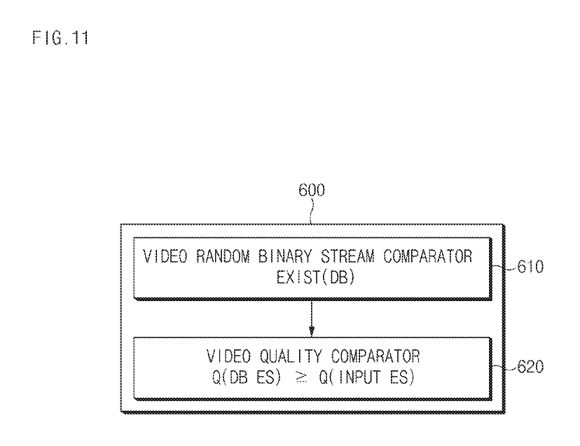

FIG. 11 is a diagram illustrating a detailed configuration of a video replacement determiner 600 of FIG. 1.

The video replacement determiner 600 may include a video random binary stream comparator 610 and a video quality comparator 620.

The video random binary stream comparator 610 may check whether the random binary stream calculated in the video random binary stream calculator 400 exists in the video non-duplication database 700. The video random binary stream comparator 610 may search the video having the same content through various methods of intersection concept in the video non-duplication database 700.

If the video corresponding to the random binary stream calculated in the video random binary stream calculator 400 exists in the video non-duplication database 700, the video quality comparator 620 may compare the video existing in the video non-duplication database 700 with the space-time quality value of input video. At this time, the video quality comparator 620 may perform comparing by using a comparing operator having characteristic such as intersection operation, and Hamming distance that uses XOR as a comparing operator may be a typical.

The video quality comparator 620 may perform conceptually subtraction operation of space-time quality value and compare whether it is positive or negative by integrating each value in the time axis and replace with the input video or maintain the video in the database to discard the input video. That is, if the space-time quality value of the video in the database is higher than the quality value of the input video, the input video may be discarded to maintain the video in the database. On the other hand, if the space-time quality value of the video in the database is lower than the quality value of the input video, the video in the video non-duplication database 700 may be replaced with the input video, and the fields in the database such as each space-time quality value and the random binary stream may be updated.

Usually, in normal videos, if the video ES is the same, then, the audio ES is also the same. However, in the case of supporting or dubbing multiple languages, several audio ES may exist in a single video ES. In this case, if the video is stored according to a language, the video ES may be duplicated and a lot of storage space may be wasted. Therefore, to avoid this, it is possible to use a strategy of comparing and managing the video ES and the audio ES.

Thus, when the same video exists in the database after passing the integrity verification process, the video replacement determiner 600 may compare the space-time quality values of the video inputted to the video quality comparator 620 and the video in the database determined to be identical by the random binary stream so as to determine the side to be selected and replaced.

The comparing method may vary depending on the space-time quality value, but the video ES in the video may exist in the video non-duplication database 700 and only the audio ES may be determined to be input to the video non-duplication database 700. Such a case may usually occur in the case of the aforementioned multi-lingual video. Thus, the audio ES may be assigned with a new audio ES ID while inputting to the audio ES database, and the audio ES random binary stream and the audio ES space-time quality value are input to the audio ES characteristic database and the audio ES-quality database respectively together with the audio ES ID. Then, the newly assigned audio ES ID and a video ES ID in the database may be input to the video database to be issued a video ID. In addition, the video ID and video additional information may be input to a video additional information database.

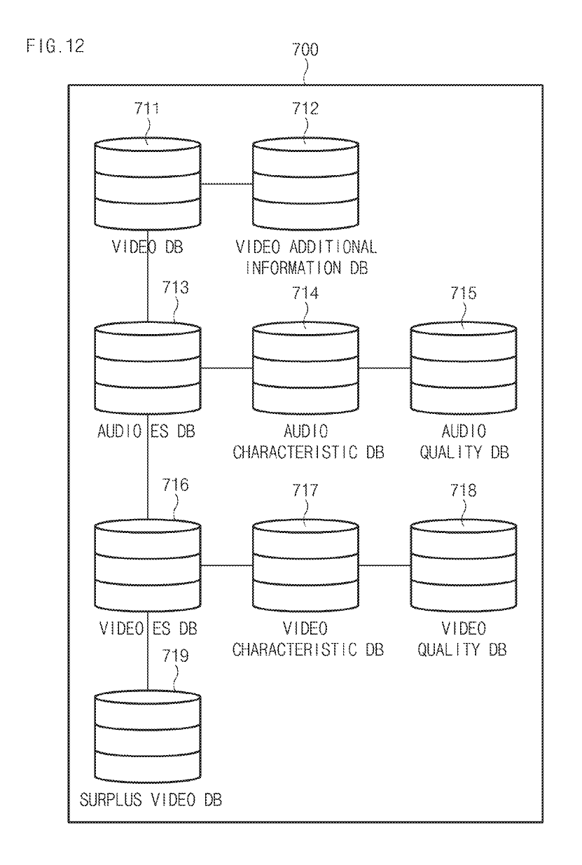

FIG. 12 is a diagram illustrating a detailed configuration of a video non-duplication database 700 of FIG. 1.

The video non-duplication database 700 may include a video DB 711, a video additional information DB 712, an audio ES DB 713, an audio characteristic DB 714, an audio quality DB 715, a video ES DB 716, a video characteristic DB 717, a video quality DB 718, and a surplus video DB 719.

The video DB 711 may store a video ID, an audio ES ID, and a video ES ID.

The video additional information DB 712 may store DCF information of corresponding video, video ES encoder information, audio ES encoder information, a file name, and the like.

The audio ES DB 713 may store the audio ES ID, and the audio ES. The audio characteristic DB 714 may store the audio ES ID and the audio ES characteristic histograms. The audio quality DB 715 may store the audio ES ID and the audio ES space-time quality values and store additional information.

The video ES DB 716 may store the video ES ID, and the video ES. The video characteristic DB 717 may store the video ES ID and the video ES characteristic histograms. The video quality DB 718 may store the video ES ID and the video ES space-time quality values.

The surplus video DB 719 may store a fingerprint or a characteristic point of corresponding video clip depending on a video clip to be removed and a method of finding the video clip to be removed.

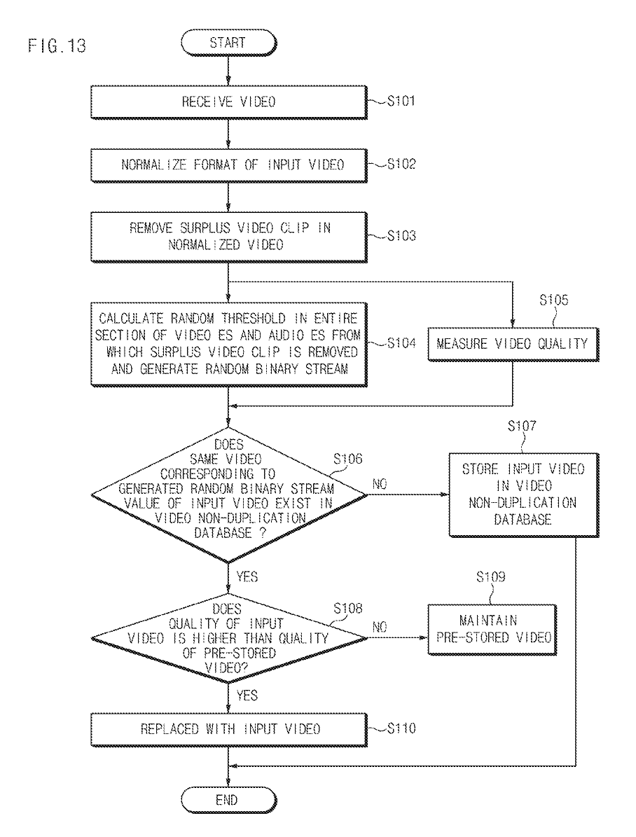

Hereinafter, a large scale video management method according to an embodiment of the present disclosure is described in detail with reference to FIG. 13.

First, when the video input unit 100 receives a video and transmits to the video preprocessor 200 (S101), the video preprocessor 200 normalizes the format of the input video (S102).

Then, the surplus video clip remover 300 removes an unnecessary surplus video clip in the normalized video (S103).

The video random binary stream calculator 400 calculates a random threshold in entire section of the video from which the surplus video clip is removed and generates a random binary stream to convey to the video replacement determiner 600 (S104).

In addition, the video quality measurer 500 measures the video quality to convey to the video replacement determiner 600 (S105).

Thus, the video replacement determiner 600 determines whether the same video corresponding to a generated random binary stream value of the video input from the video random binary stream calculator 400 exists in the video non-duplication database 700 (S106).

When the same video does not exist in the video non-duplication database 700, the input video is stored in the video non-duplication database 700 (S107).

Meanwhile, if the same video exists in the video non-duplication database 700, the quality of the input video is compared with the quality of the same video stored in the video non-duplication database 700 (S108), and if the quality of the input video is lower than the quality of a previously stored video, the previously stored video is maintained (S109).

On the other hand, by comparing the quality of the same video (S108), if the quality of the input video is higher than the quality of a previously stored video, the previously stored video is replaced with the input video (S110).

Thus, the present disclosure may extract entire section random binary stream of video and audio ES from the input video and determine at a high speed whether duplication occurs, and compare the video with the quality of the input video to store a high quality video in the video non-duplication database.

In this case, before determining the update of the video non-duplication database, even when re-encoding or obtaining the video with an impure intention, the video quality measurer 500 may check the quality integrity and perform filtering.

By using the technology present disclosure, an entire section of video may be determined at a high speed whether there exists duplication, and the video which has the same audio ES or the same video ES among a corresponding video may be managed selectively. Further, firstly, the present disclosure may be able to search the video having duplicated content at a high speed from a large scale video management system such as cloud, and, further, check the integrity using the priority of duplication replacement and may be able to replace a video of low quality with better quality video. The present disclosure may be utilized for a small-scale group home entertainment server which is available for family or utilized for a personal NAS server.

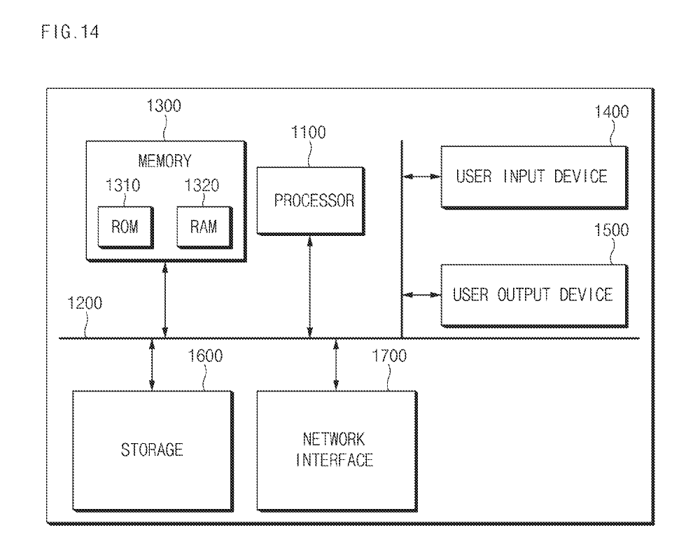

FIG. 14 is a diagram illustrating a computer system implementing the large scale video management method according to an embodiment of the present disclosure.

Referring to FIG. 14, a computing system 1000 may include at least one processor 1100 which is connected via a bus 1200, memory 1300, an user interface input device 1400, an user interface output device 1500, a storage 1600, and a network interface 1700.

The processor 1100 may be a semiconductor device for performing a processing for instructions stored in a central processing unit (CPU) or the memory 1300 and/or the storage 1600. The memory 1300 and the storage 1600 may include various types of volatile and nonvolatile storage media. For example, the memory 1300 may include a Read Only Memory (ROM) and a Random Access Memory (RAM).

Thus, the steps of the method or the algorithm described in association with the embodiments disclosed herein may be directly implemented by a hardware, a software module, or a combination of the two executed by the processor 1100. The software module may reside in a storage medium (i.e., in the memory 1300 and/or the storage 1600) such as a RAM memory, a flash memory, a ROM memory, an EPROM memory, an EEPROM memory, a register, a hard disk, a removable disk, and CD-ROM.

The exemplary storage medium may be coupled to the processor 1100, and the processor 1100 may read information from the storage medium and write information to the storage medium. Alternatively, the storage medium may be integrated in the processor 1100. The processor and the storage medium may reside in an application specific integrated circuit (ASIC). The ASIC may reside in a user terminal. Alternatively, the processor and the storage medium may reside in the user terminal as an individual component.

The present technology is capable of rapidly determining duplication of video by comparing a random binary stream of the entire video, measuring quality to check quality integrity, and selectively replacing with only high-quality video, so that it is possible to efficiently manage large scale video.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A large scale video management system comprising:
a video random binary stream calculator configured to generate a video random binary stream while changing a setting of a random threshold in an entire section of an input video;
a video quality measurer configured to measure a quality of the input video; and
a video replacement determiner configured to search whether a video having the same value as the video random binary stream generation value is previously stored, and compare a quality of the previously stored video with a quality of the input video to replace with a high quality video when the video having the same value as the video random binary stream generation value is previously stored.

2. The large scale video management system of claim 1, further comprising a surplus video clip remover that identifies and removes a surplus video clip which is unnecessary information in the video.

3. The large scale video management system of claim 2, wherein the surplus video clip remover comprises:
a video clip identifier configured to identify whether there is a surplus video clip in a video input from a video preprocessor; and
a video clip remover configured to receive information on a section where the surplus video clip exists from the video clip identifier and to remove the surplus video clip.

4. The large scale video management system of claim 3, wherein the surplus video clip remover removes a portion corresponding to a section of the surplus video clip received from the video clip identifier in a video elementary stream (ES) and an audio ES of the input video, and updates time information and removes the same section in the video ES and the audio ES of the input video to be stored in the video non-duplication database.

5. The large scale video management system of claim 1, further comprising a video preprocessor configured to normalize a format of the video.

6. The large scale video management system of claim 5, wherein the video preprocessor comprises:
a video de-multiplexer configured to multiplex the video into a video elementary stream (ES) and an audio ES;
a video decoder configured to decode the de-multiplexed video ES and audio ES; and
a video normalizer configured to normalize a format of the decoded video.

7. The large scale video management system of claim 1, wherein the video random binary stream calculator comprises:
a video cube generator configured to generate a single cube for the input video and generate a frame by stacking a single cube as several layers;
a video characteristic calculator configured to extract characteristic for the cube;
a video random threshold calculator configured to calculate a video random threshold by using the extracted characteristic; and
a video binary stream calculator configured to calculate the video random binary stream by using the video random threshold.

8. The large scale video management system of claim 1, wherein the video quality measurer comprises:
a video quality calculator configured to calculate a quality of the input video; and
a video integrity verifier configured to verify integrity of the input video.

9. The large scale video management system of claim 1, wherein the video replacement determiner comprises:
a video random binary stream comparator configured to determines whether a video corresponding to the random binary stream of the input video is previously stored; and
a video quality comparator configured to compare the previously stored video with a quality of the input video, when the video corresponding to the random binary stream of the input video is previously stored.

10. The large scale video management system of claim 9, wherein the video quality comparator maintains the previously stored video when a quality of the previously stored video is higher than a quality of the input video.

11. The large scale video management system of claim 9, wherein the video quality comparator replaces the previously stored video with the input video when a quality of the previously stored video is lower than a quality of the input video.

12. The large scale video management system of claim 1, further comprising a video non-duplication database configured to store at least one of a non-duplication video, video information, video additional information, and surplus video clip information.

13. A large scale video management method comprising:
generating a video random binary stream while changing a setting of a random threshold in an entire section of an input video;
measuring a quality of the input video;
searching whether a video having the same value as the video random binary stream generation value is previously stored;
comparing a quality of the previously stored video with a quality of the input video, when the video having the same value as the video random binary stream generation value is previously stored; and
replacing with a high quality video among the previously stored video and the input video.

14. The large scale video management system of claim 13, before generating a video random binary stream, further comprising normalizing a format of the input video.

15. The large scale video management system of claim 14, further comprising identifying and removing a surplus video clip which is unnecessary information in the normalized video.
